(19) United States
(12) Patent Application Publication
(10) Pub. No.: US 2026/0274659 A1
(43) Pub. Date: Sep. 17, 2026

(54) COUNTER-FLOW ELECTRIC FURNACE & METHODS

(71) Applicant: SABIC GLOBAL TECHNOLOGIES B.V., Bergen op Zoom (NL)

(72) Inventor: Michael Edward HUCKMAN, Sugar Land, TX (US)

(73) Assignee: SABIC GLOBAL TECHNOLOGIES B.V., Bergen op Zoom (NL)

(21) Appl. No.: 19/167,939

(22) PCT Filed: Mar. 19, 2024
(86) PCT No.: PCT/EP2024/057327

§ 371 Date: Sep. 23, 2025

(30) Foreign Application Priority Data
Mar. 24, 2023 (EP) 23164114.3

(51) Int. Cl. C01B 3/26

(52) U.S. Cl. CPC C01B 3/26; C01B 2203/0233; C01B 2203/085

(57) ABSTRACT

Radiative electric furnaces and methods of heating fluid are disclosed. The furnace can include a housing defining a radiant heating chamber having a length, a width, and a height; one or more first electric heating elements disposed on a first side of the radiant heating chamber; one or more second electric heating elements disposed on a second side of the radiant heating chamber and spaced apart from the first electric heating element(s); a plurality of first tubes disposed between the first and second electric heating elements, and extending at least a majority of the length of the radiant heating chamber; and a plurality of second tubes disposed between the first and second electric heating elements, and extending at least a majority of the length of the radiant heating chamber.

### FIELD OF DISCLOSURE

The present disclosure is generally related to processes for producing chemicals and, more particularly but not by way of limitation, to radiative electric furnaces for chemical synthesis such as syngas synthesis or steam reforming, and methods of heating fluids using such a radiative electric furnace.

### BACKGROUND

Chemical synthesis plants are utilized to provide a variety of chemicals. Often, a dedicated fuel is burned or combusted to provide heat of reaction for chemical synthesis, energy to heat one or more process streams, energy to vaporize liquids (e.g., boil water used as a diluent), energy to do work (e.g., drive a compressor or pump), or energy for other process operations throughout the chemical synthesis plant. Such burning or combustion of fuels results in the production of flue gases, which can be harmful to the environment, and also results in a loss of energy efficiency of the process. Likewise, steam is often conventionally utilized as a plant-wide heat and/or energy transfer fluid within chemical synthesis plants. The steam utilized for the heat and/or energy transfer is often produced via the combustion of a fuel, resulting in the production of additional flue gas and further energy efficiency losses during the chemical synthesis. Additionally, the use of a material that could otherwise be utilized as a reactant for combustion as a fuel also reduces an amount of the desired chemical product produced in the chemical synthesis plant from a given amount of the material. Accordingly, efforts have been made to convert certain components of chemical synthesis to being powered by electrical energy rather than direct combustion of fossil fuels.

However, the electrification of certain components in chemical synthesis plants presents additional issues and challenges. For example, electric furnaces may present issues or may be subject to considerations that are different than and/or not necessarily present in combustion furnaces.

### SUMMARY

The present disclosure includes steam radiative electric furnaces, and methods of heating fluids in such radiative electric furnaces, that reduce local temperature peaks and temperature gradients in electric heating elements of the furnace, for example, to extend the useful life of the electric heating elements. More particularly, the present furnaces include tubes for carrying fluid to be heated between the electric heating elements and, by alternative the flow direction of such tubes, local maximum and minimum tube temperatures are distributed throughout the interior of the heater, thereby taking advantage of the exchange of thermal radiation between relatively hotter and cooler surfaces to reduce the local temperature peaks otherwise experienced by heating elements and increasing useful life of the heating elements.

Some configurations of the present radiative electric furnaces comprise: a housing defining a radiant heating chamber having a length, a width, and a height; one or more first electric heating elements disposed on a first side of the radiant heating chamber; one or more second electric heating elements disposed on a second side of the radiant heating chamber and spaced apart from the first electric heating element(s); a plurality of first tubes disposed between the first and second electric heating elements, and extending at least a majority of the length of the radiant heating chamber; and a plurality of second tubes disposed between the first and second electric heating elements, and extending at least a majority of the length of the radiant heating chamber. In some such configurations, the first tubes are configured to carry a fluid from a first end of the radiant heating chamber toward a second end of the radiant heating chamber, and the second tubes are configured to carry a fluid from a second end of the radiant heating chamber toward a first end of the radiant heating chamber; and at least one of the second tubes is disposed one of (a)-(c): (a) between two of the first tubes; (b) between one of the first tubes and one of the first and second electric heating elements; or (c) both (a) and (b).

In some configurations of the present radiative electric furnaces, the first and second tubes are arranged in two rows of tubes, a first one of the two rows is disposed closer to the first electric heating element(s) than to the second electric heating element(s), and a second one of the two rows is disposed between the first row and the second electric heating element(s). In some such configurations, the first row comprises all of the first tubes, and the second row comprises all of the second tubes. In other configurations, the first and second rows each comprises alternating first and second tubes.

In some configurations of the present radiative electric furnaces, the furnace is a steam reforming reactor and further comprises: a steam-reforming catalyst configured to cause steam and methane gas to react to form hydrogen and carbon monoxide.

In some configurations of the present radiative electric furnaces, the first and second electric heating elements are configured to reach a maximum temperature in excess of 1000° C.

Some configurations of the present radiative electric furnaces further comprise a fluid inlet in fluid communication with each of the first and second tubes via one or more manifolds.

In some implementations of the present methods of heating a fluid in a radiative electric furnace, the method comprises: directing the fluid into a plurality of tubes between first and second electric heating elements disposed on opposing sides of a radiant heating chamber of the furnace, the tubes extending along a length of the heating chamber; where the plurality of tubes comprises a plurality of first tubes and a plurality of second tubes, and directing the fluid comprises simultaneously: (1) directing a first portion of the fluid into the first tubes in a first direction extending from a first end of the heating chamber toward a second end of the heating chamber; and (2) directing a second portion of the fluid into the second tubes in a second direction extending from a second end of the heating chamber toward the first end of the heating chamber.

In some implementations of the present methods, the first and second tubes are arranged in two rows of tubes, a first one of the two rows is disposed closer to the first electric heating element(s) than to the second electric heating element(s), and a second one of the two rows is disposed between the first row and the second electric heating element(s). In some such implementations, the first row comprises all of the first tubes, and the second row comprises all of the second tubes. In other implementations, the first and second rows each comprises alternating first and second tubes.

In some implementations of the present methods, the furnace is a steam reforming reactor, a steam-reforming catalyst is disposed in the tubes, and the fluid directed into the tubes comprises steam and methane gas. Some such implementations further comprise: receiving fluid from the plurality of tubes, the received fluid comprising hydrogen and carbon monoxide. In some such implementations, each of the first and second heating elements exhibits a maximum temperature (T_{MAX}) and an average temperature (T_{AVE}); and where, as the fluid flows through the plurality of tubes, the difference between T_{MAX} and T_{AVE} (T_{MAX}−T_{AVE}) is less than five percent (5%) of T_{MAX}. In some such implementations, the first and second electric heating elements reach a maximum temperature in excess of 1000° C. while the fluid flows through the plurality of tubes.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any embodiment of the present apparatuses, kits, and methods, the term “substantially” may be substituted with “within [a percentage] of” what is specified, where the percentage includes 0.1, 1, 5, and/or 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, an apparatus or kit that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Further, an apparatus, device or system that is configured in a certain way is configured in at least that way, but it can also be configured in other ways than those specifically described.

Any embodiment of any of the present apparatuses and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

Some details associated with the aspects of the present disclosure are described above, and others are described below. Other implementations, advantages, and features of the present disclosure will become apparent after review of the entire application, including the Brief Description of the Drawings, Detailed Description, and the Claims.

### BRIEF DESCRIPTION OF THE DRAWINGS

The following drawings illustrate by way of example and not limitation. For the sake of brevity and clarity, every feature of a given structure is not always labeled in every figure in which that structure appears. Identical labels or reference numbers do not necessarily indicate an identical structure. Rather, the same reference number may be used to indicate a similar feature or a feature with similar functionality, as may non-identical reference numbers. Dimensioned figures are drawn to scale (unless otherwise noted), meaning the sizes of the depicted elements are accurate relative to each other for at least the embodiment depicted in the figures.

FIG. 1 depicts block flow diagram of a generalized methanol synthesis plant or process.

FIG. 2 depicts a block diagram of a radiative electric heater that may be configured for use in the syngas synthesis section of the plant or process of FIG. 1.

FIGS. 3A and 3B, respectively, depict a conceptual block diagram of a first example of a unidirectional-flow electric furnace for use in the reforming section of FIG. 2, and a cutaway perspective view of the upper and lower walls and fluid tubes of the electric furnace of FIG. 3A.

FIGS. 4A and 4B, respectively, depict a conceptual block diagram of a first example of the present counter-flow electric furnaces for use in the reforming section of FIG. 2, and a cutaway perspective view of the upper and lower walls and fluid tubes of the electric furnace of FIG. 4A.

FIG. 4C depicts a chart of temperature profile of the fluid tubes of the furnace of FIGS. 4A and 4B.

FIGS. 5A and 5B depict cutaway perspective views of second and third examples of the present counter-flow electric furnaces for the syngas synthesis section of FIG. 2.

FIGS. 6A, 6B, and 6C depict charts of temperature profiles of the fluid tubes of a dual-row unidirectional flow furnace, of the furnace of FIG. 5A, and of the furnace of FIG. 5B.

### DETAILED DESCRIPTION

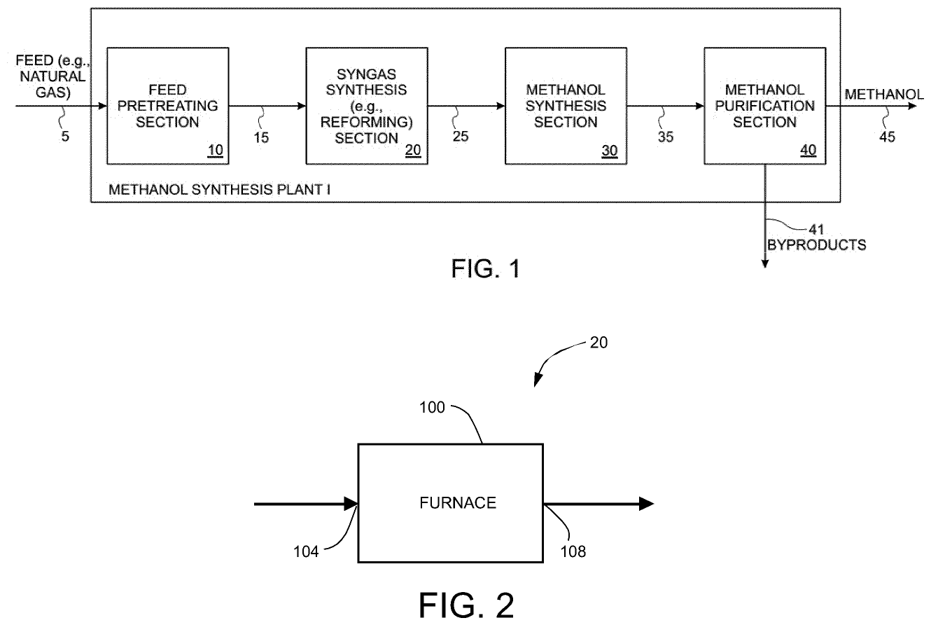

Referring now to the drawings, and more particularly to FIG. 1, shown there is a block flow diagram of an example of a generalized methanol synthesis plant, which includes one or more of the following process sections for converting a feed stream 5 into a methanol product stream 45 (and optionally one or more byproduct streams 41): a feed pretreating section 10, a syngas synthesis section 20, a methanol synthesis section 30, a methanol purification section 40, or a combination thereof. Such sections will be described briefly in the next few paragraphs, and in more detail hereinbelow.

As indicated in the methanol synthesis block flow diagram, a feed pretreating section 10 of a methanol synthesis plant is operable to prepare (e.g., remove undesirable components (e.g., sulfur) from, adjust temperature and/or pressure of) a feed 5 for reforming, providing a pretreated feed 15. In some applications, a methanol synthesis plant of this disclosure does not comprise a feed pretreating section. A syngas synthesis section 20 is operable to produce synthesis gas from feed 5 or pretreated feed 15 to produce a syngas synthesis product 25 comprising carbon monoxide (CO) and hydrogen (H₂).

In some implementations, syngas generation section 20 is a syngas synthesis section operable to carry out steam reforming of the feed (e.g., of a feed 5 or pretreated feed 15 comprising natural gas) to produce a reformer product comprising carbon monoxide (CO) and hydrogen (H₂). The syngas synthesis (or ‘reformer’) product 25 can further comprise carbon dioxide (CO₂), water, methane (CH₄), and/or impurities. For example, some embodiments of the present electric furnaces can comprise a steam reforming catalyst to carry out the syngas reaction to produce carbon monoxide and hydrogen.

A methanol synthesis section 30 is operable to produce methanol from the syngas synthesis product 25 and thus provide a crude methanol stream 35. A methanol purification section 40 is operable to separate a purified methanol product 45 and byproducts 41 from the crude methanol stream 35.

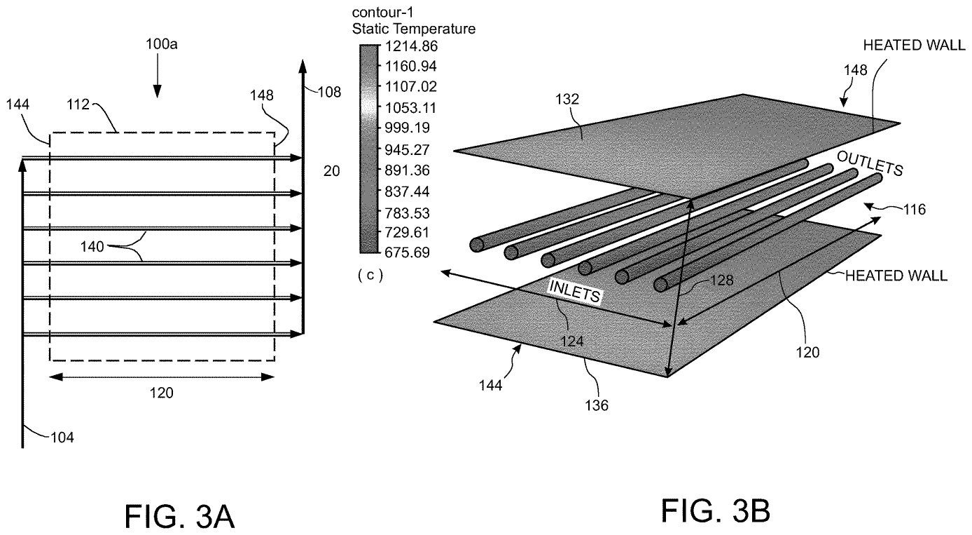

Referring now to FIG. 2, shown there is a block diagram of a radiative electric heater 100 that may be configured for use in the syngas synthesis (steam reforming) section 20 of the plant or process of FIG. 1. As shown in FIG. 2, the furnace generally includes a fluid inlet 104 and a fluid outlet 108.

FIGS. 1 and 2 depict one example of a methanol synthesis system for illustration purposes, but the present radiative electric furnaces can be used in any of various chemical synthesis systems and processes, particularly in place of furnaces that have historically been powered by direct combustion or fossil fuels.

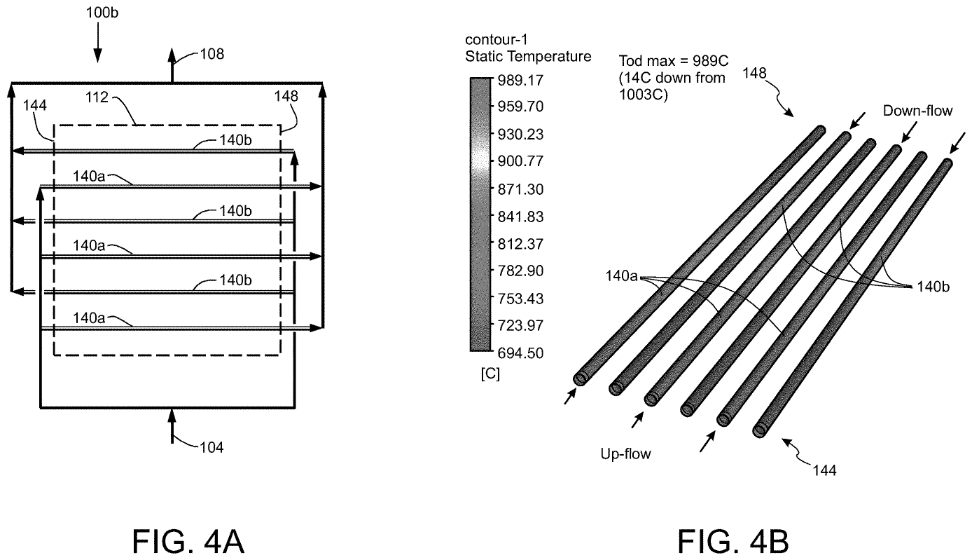

Referring now to FIGS. 3A-3B; FIG. 3A depicts a conceptual block diagram of a first example 100a of a unidirectional-flow electric furnace suitable for use in chemical synthesis systems and processes (e.g., configurable for use in the syngas synthesis section 20 of the methanol synthesis system of FIG. 1); and FIG. 3B depicts a cutaway perspective view of upper and lower walls and fluid tubes of the electric furnace of FIG. 3A. As shown, furnace 100a generally includes fluid inlet 104 and a fluid outlet 108, a housing 112 defining a radiant heating chamber 116 having a length 120, a width 124, and a height 128. Furnace 100a also includes one or more first electric heating elements 132 disposed on a first side of the radiant heating chamber, and one or more second electric heating elements 136 disposed on a second side of the radiant heating chamber and spaced apart from the first electric heating element(s). The furnace also comprises a plurality of tubes 140 in fluid communication with the fluid inlet (104) and the fluid outlet (108). As shown, tubes 140 are disposed between the first and second electric heating elements 132, 136, and extend at least a majority of the length (120) of radiant heating chamber 116. In this conventional configuration, the tubes are configured such that fluid flows through all of the tubes in a first direction from a first end 144 of the radiant heating chamber toward a second end 148 of the chamber.

By way of example, at least some steam methane reforming (SMR) furnaces heat the fluid from a first temperature (e.g., of from about 650° C. to about 750° C.) to a second temperature (e.g., of from about 750° C. to about 900° C.), at pressures of 15-45 bar (e.g., 20-40 bar), in tubes having a diameter of from about 4 inches to about 6 inches that are packed with catalyst. In such SMR furnaces, the tubes typically have a constant diameter from inlet portion to outlet portion in the furnace and each tube typically extends a single pass (as opposed to multiple passes) across the furnace.

In the configuration of FIGS. 3A-3B, the lower-temperature fluid entering the heating chamber is able to absorb more thermal energy at the first end 144 than the higher-temperature fluid exiting the chamber is able to absorb at the second end 148. As a result, the temperature of the heating elements 132, 136 is increased at the second end 148, which can be problematic for the heating elements because radiative heating element lifetime is typically shortened with time spent at or near maximum temperature. Additionally, temperature gradients between the first end 144 and the second end 148 can introduce mechanical stresses in the heater housing, such as in the housing wall to which the element is coupled.

The depicted configuration was modeled for steam methane reforming at an inlet temperature of 565° C., flow rate of 0.124 kilograms per second (kg/s), and a pressure of 41.75 bar using a Reaction Channel model in Fluent. The model implemented four major SMR reactions, including:

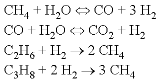

These reactions were modeled with a C₂H₆ mass fraction of 0.01769, an H₂ mass fraction of 0.00137, an H₂O mass fraction of 0.76209, a CO₂ mass fraction of 0.00174, a CH₄ mass fraction of 0.1987, an N₂ mass fraction of 0.01077, and a C₃H₈ mass fraction of 0.00748.

The modeled tubes each had an internal diameter of 127 millimeters (mm), a length of 12.2 meters (m) within the furnace, and a wall thickness of 10 mm. Radiative heaters were modeled on opposing walls (as in FIG. 3B), with a combined surface area of 70 m² and a thermal power input of 0.4 Megawatts (MW) per tube. In this configuration, modeling revealed—for the six-tube, unidirectional-flow configuration—tube temperature varying from about 675° C. at the heater inlet to about 1,003° C. (maximum circumferential average of about 985° C.) at the heater outlet, and, for the heaters (or heated walls) themselves, a maximum temperature of about 1,215° C. (average heater temperature of about 1151° C.).

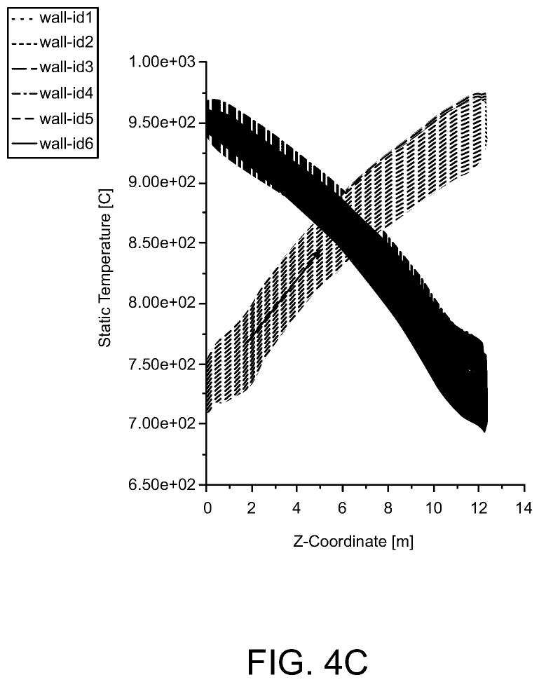

Referring now to FIGS. 4A-4C; FIG. 4A depicts a conceptual block diagram of a first example 100b of a counter-flow electric furnace suitable for use in chemical synthesis systems and processes (e.g., configurable for use in the syngas synthesis section 20 of the methanol synthesis system of FIG. 1); FIG. 4B depicts a cutaway perspective view of fluid tubes of the electric furnace of FIG. 4A; and FIG. 4C depicts a chart of temperature profile of the fluid tubes of the furnace 100b. Furnace 100b is similar to furnace 100a, with the exception that furnace 100b is configured to direct a first part of the fluid in a first direction through the heating chamber, and a second part of the fluid in a second direction through the heating chamber. More specifically, furnace 100b is configured (e.g., via one or more manifolds) to direct a first part of the fluid from inlet 104 to a plurality of first tubes 140a, and a second part of the fluid from inlet 104 to a plurality of second tubes 140b, and to direct the first and second parts of the fluid from the tubes (e.g., via one or more manifolds) to an outlet 108. First tubes 140a are configured to carry fluid in a first direction from first end 144 of the radiant heating chamber toward second end 148 of the radiant heating chamber, and second tubes 140b are configured to carry fluid in a second direction from second end 148 of the radiant heating chamber toward first end 144 of the radiant heating chamber. In this configuration, the first and second tubes 140a, 140b are alternated (140a, 140b, 140a, 140b, 140a, 140b) along the width 128 of the heating chamber. As shown, tubes 140b are parallel to each other and to tubes 140a, such that the second direction is parallel and opposite to the first direction.

In this configuration, the lower-temperature ends of the first tubes 140a are disposed at first end 144 of the heating chamber, and the lower-temperature ends of the second tubes 140b are disposed at second end 148 of the heating chamber. Thus, the lower temperature ends of the first tubes 140a help to thermally balance the higher-temperature ends of the second tubes 140b such that the lower-temperature ends of the first tubes 140a can absorb thermal energy from the heating elements at the first end 144; and the lower-temperature ends of the second tubes 140b help to thermally balance the higher-temperature ends of the first tubes 140a such that the lower-temperature ends of the second tubes 140b can absorb thermal energy from the heating elements at the second end 148. As a result, the temperature of the heating elements 132, 136 is approximately equivalent at the first end 144 and the second end 148, lowering the maximum temperature (and increasing useful life) of the heating elements and reducing the temperature gradient (and resulting mechanical stresses) across each heating element.

This counter-flow configuration was modeled with the same parameters as described above for FIGS. 3A-3B. In the counter-flow configuration of FIGS. 4A-4C, modeling revealed—for the six-tube, counter-flow configuration-tube temperature varying from about 730° C. at the heater inlet to about 975° C. (maximum circumferential average of about 940° C.) at the heater outlet, and, for the heaters (or heated walls) themselves, a maximum temperature of about 1,186° C. (average heater temperature of about 1157° C.).

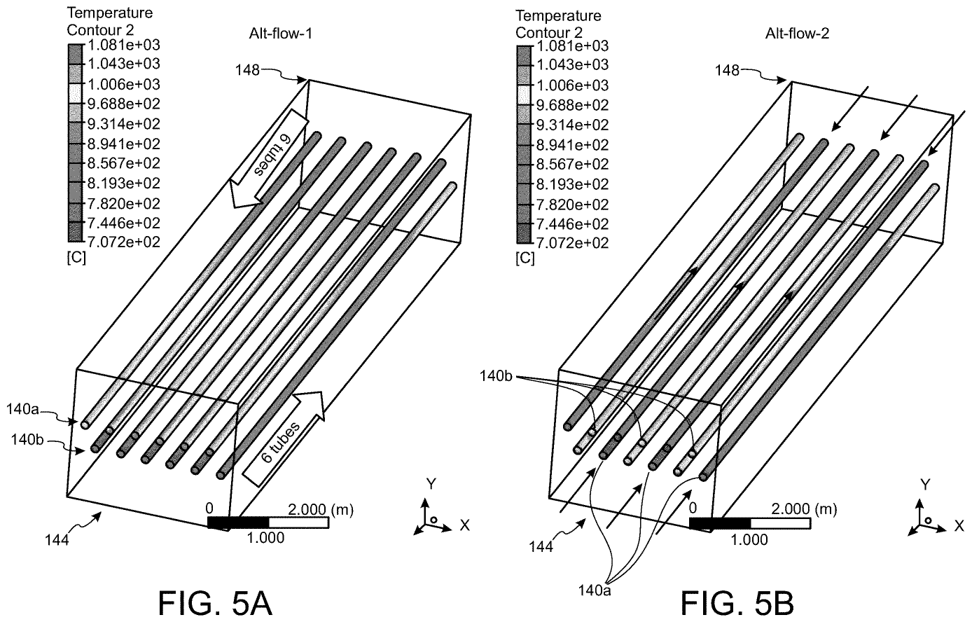

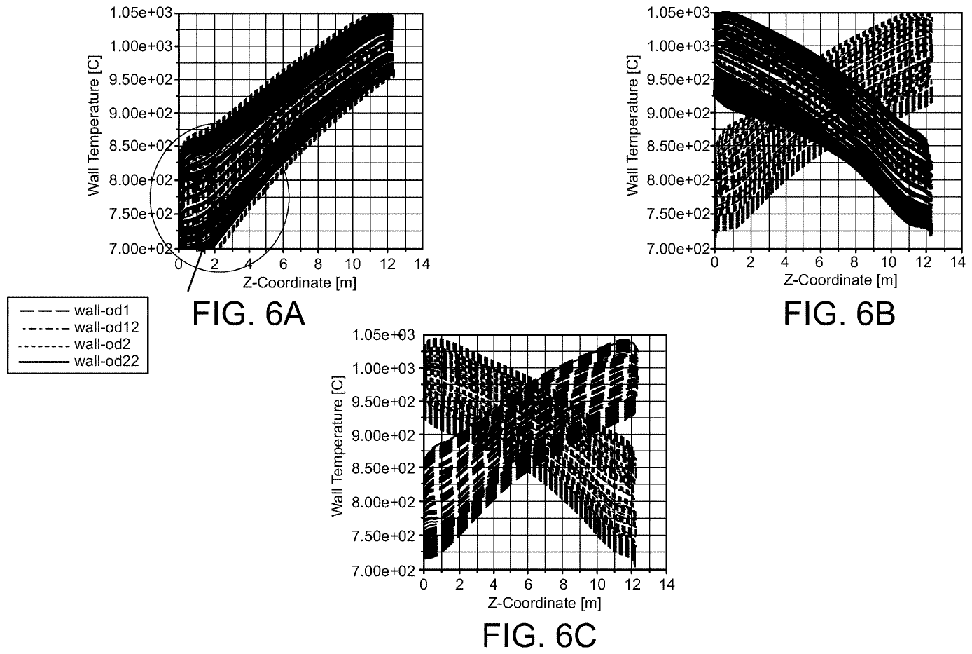

Referring now to FIGS. 5A-5B and 6A-6C; FIGS. 5A and 5B respectively depict cutaway perspective views of second and third examples 100c, 100d of the present counter-flow electric furnaces for the reforming section of FIG. 2; and FIGS. 6A, 6B, and 6C respectively depict charts of temperature profiles of the fluid tubes of a dual-row unidirectional flow furnace, of the furnace of FIG. 5A, and of the furnace of FIG. 5B. Furnaces 100c and 100d each depict dual-row configurations in which the first and second tubes 140a, 140b are arranged in two rows of tubes. In furnace 100c (FIG. 5A), all of the first tubes 140a are disposed in a first (upper) row that is closer to the first (upper) electric heating element(s), and all of the second tubes 140b are disposed in a second (lower) row between the first row and the second (lower) electric heating element(s). In contrast, in furnace 100d (FIG. 5B), the first (upper) and second (lower) rows each comprises alternating first and second tubes (140a, 140b, 140a, 140b, etc.), with the first (upper) row starting (on the left side, in the depicted orientation) with a first tube 140a, and the second (lower) row starting (on the left side, in the depicted orientation) with a second tube 140b so that in the vertical direction, each first tube 140a is paired with a second tube 140b. In this configuration, each tube of the first (upper) row is aligned vertically with a corresponding tube of the second (lower) row. In other configurations, the first (upper) row can be laterally offset (in the width direction) relative to the second (lower) row.

As described above for furnace 100b, in these configurations of furnace 100c and 100d, the lower-temperature ends of the first tubes 140a are disposed at first end 144 of the heating chamber, and the lower-temperature ends of the second tubes 140b are disposed at second end 148 of the heating chamber. Thus, the lower temperature ends of the first tubes 140a help to thermally balance the higher-temperature ends of the second tubes 140b such that the lower-temperature ends of the first tubes 140a can absorb thermal energy from the heating elements at the first end 144; and the lower-temperature ends of the second tubes 140b help to thermally balance the higher-temperature ends of the first tubes 140a such that the lower-temperature ends of the second tubes 140b can absorb thermal energy from the heating elements at the second end 148. As a result, the temperature of the heating elements 132, 136 is approximately equivalent at the first end 144 and the second end 148, lowering the maximum temperature (and increasing useful life) of the heating elements and reducing the temperature gradient (and resulting mechanical stresses) across each heating element.

This counter-flow configurations of each of FIGS. 5A and 5B were modeled with the same parameters as described above for FIGS. 3A-3B. In the counter-flow configuration of FIGS. 5A-5B, modeling revealed—for the twelve-tube, counter-flow configurations-tube temperature varying from about 660° C. at the heater inlet to about 1,093° C. at the heater outlet, and, for the heaters (or heated walls) themselves, a maximum temperature of 1,281° C. and average temperature of 1,229° C. In contrast, modeling of a similar twelve-tube furnace instead having unidirectional flow through the same two rows of tubes-heating the same fluid over a similar temperature range results in a maximum circumferential maximum average tube temperature of 1,002° C., and the heaters (or heated walls) experiencing element varying from a low temperature of approximately 1165° C. at the first end 144 to a high temperature of approximately 1305° C., with an average temperature of approximately 1,220° C. As such, the counter-flow configurations of the modeled dual-layer furnaces reduce maximum heater temperature and temperature gradients, which can be expected to improve the useful life of the heater. Table 1 summarizes certain key differences between the foregoing configurations.

TABLE 1

| | | 1-row | | 2-row | 2-row |
|---|---|---|---|---|---|
| | 1-row | alternating | 2-row uni- | alternating | alternating |
| | parallel flow | flow | directional | flow | flow |
| ° C. | (FIG. 3B) | (FIG. 4B) | flow | (FIG. 5A) | (FIG. 5B) |
| Max Tube Temperature | 985 | 940 | 1002 | 980 | 980 |
| (circumferential average) | | | | | |
| Max Heater Temperature | 1215 | 1186 | 1305 | 1281 | 1281 |
| Average Heater Temperature | 1151 | 1157 | 1220 | 1229 | 1229 |

In certain implementations of the present methods of heating a fluid in a radiative electric furnace (e.g., 100b, 100c, 100d), the method comprises: directing the fluid into a plurality of tubes (e.g., 140) between first and second electric heating elements (e.g., 132, 136) disposed on opposing sides of a radiant heating chamber (e.g., 116) of the furnace, the tubes extending along a length (e.g., 124) of the heating chamber. In such implementations, the plurality of tubes comprises a plurality of first tubes (e.g., 140a) and a plurality of second tubes (e.g., 140b), and directing the fluid comprises simultaneously: directing a first portion of the fluid into the first tubes (e.g., 140a) in a first direction extending from a first end (e.g., 144) of the heating chamber toward a second end (e.g., 148) of the heating chamber; and directing a second portion of the fluid in a second direction into the second tubes in a second direction extending from a second end (e.g., 148) of the heating chamber toward the first end (e.g., 144) of the heating chamber.

In some implementations of the present methods, the furnace is a steam reforming reactor, a steam-reforming catalyst is disposed in the tubes, and the fluid directed into the tubes comprises steam and methane gas. Some such implementations further comprise: receiving fluid from the plurality of tubes, the received fluid comprising hydrogen and carbon monoxide.

In some implementations of the present methods, the heating elements exhibit a maximum temperature (T_{MAX}) and an average temperature (T_{AVE}); and, as the fluid flows through the plurality of tubes, the difference between T_{MAX} and T_{AVE} (T_{MAX}−T_{AVE}) is less than five percent (5%) of T_{MAX}. In some implementations of the present methods, the first and second electric heating elements reach a maximum temperature in excess of 1200° C. while the fluid flows through the plurality of tubes.

Additional details about various components of syngas synthesis plants and processes can be found in International Patent Application Publication No. WO2020/150247, which is incorporated by reference in its entirety.

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than the one shown may include some or all of the features of the depicted embodiment. For example, components may be combined as a unitary structure, and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above May relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A radiative electric furnace comprising:
a housing defining a radiant heating chamber having a length, a width, and a height;
one or more first electric heating elements disposed on a first side of the radiant heating chamber;
one or more second electric heating elements disposed on a second side of the radiant heating chamber and spaced apart from the first electric heating element(s);
a plurality of first tubes disposed between the first and second electric heating elements, and extending at least a majority of the length of the radiant heating chamber; and
a plurality of second tubes disposed between the first and second electric heating elements, and extending at least a majority of the length of the radiant heating chamber;
where the first tubes are configured to carry a fluid from a first end of the radiant heating chamber toward a second end of the radiant heating chamber, and the second tubes are configured to carry a fluid from a second end of the radiant heating chamber toward a first end of the radiant heating chamber; and
where at least one of the second tubes is disposed one of (a)-(c):
(a) between two of the first tubes;
(b) between one of the first tubes and one of the first and second electric heating elements; or
(c) both (a) and (b).

2. The radiative electric furnace of claim 1, where the first and second tubes are arranged in two rows of tubes, a first one of the two rows is disposed closer to the first electric heating element(s) than to the second electric heating element(s), and a second one of the two rows is disposed between the first row and the second electric heating element(s).

3. The radiative electric furnace of claim 2, where the first row comprises all of the first tubes, and the second row comprises all of the second tubes.

4. The radiative electric furnace of claim 2, where the first and second rows each comprises alternating first and second tubes.

5. The radiative electric furnace of claim 1, where the furnace is a steam reforming reactor and further comprises:
a steam-reforming catalyst configured to cause steam and methane gas to react to form hydrogen and carbon monoxide.

6. The radiative electric furnace of claim 1, where the first and second electric heating elements are configured to reach a maximum temperature in excess of 1000° C.

7. The radiative electric furnace of claim 1, further comprising a fluid inlet in fluid communication with each of the first and second tubes via one or more manifolds.

8. A method of heating a fluid in a radiative electric furnace, the method comprising:
directing the fluid into a plurality of tubes between first and second electric heating elements disposed on opposing sides of a radiant heating chamber of the furnace, the tubes extending along a length of the heating chamber;
where the plurality of tubes comprises a plurality of first tubes and a plurality of second tubes, and directing the fluid comprises simultaneously:
directing a first portion of the fluid into the first tubes in a first direction extending from a first end of the heating chamber toward a second end of the heating chamber; and
directing a second portion of the fluid into the second tubes in a second direction extending from a second end of the heating chamber toward the first end of the heating chamber.

9. The method of claim 8, where the first and second tubes are arranged in two rows of tubes, a first one of the two rows is disposed closer to the first electric heating element(s) than to the second electric heating element(s), and a second one of the two rows is disposed between the first row and the second electric heating element(s).

10. The method of claim 9, where the first row comprises all of the first tubes, and the second row comprises all of the second tubes.

11. The method of claim 9, where the first and second rows each comprises alternating first and second tubes.

12. The method of claim 8, where the furnace is a steam reforming reactor, a steam-reforming catalyst is disposed in the tubes, and the fluid directed into the tubes comprises steam and methane gas.

13. The method of claim 12, further comprising:
receiving fluid from the plurality of tubes, the received fluid comprising hydrogen and carbon monoxide.

14. The method of claim 12, where each of the first and second heating elements exhibits a maximum temperature (T_{MAX}) and an average temperature (T_{AVE}); and where, as the fluid flows through the plurality of tubes, the difference between T_{MAX} and T_{AVE} (T_{MAX}−T_{AVE}) is less than five percent (5%) of T_{MAX}.

15. The method of claim 12, where the first and second electric heating elements reach a maximum temperature in excess of 1000° C. while the fluid flows through the plurality of tubes.
